(19) United States
(12) Patent Application Publication
(10) Pub. No.: US 2011/0238400 A1
(43) Pub. Date: Sep. 29, 2011

(54) DEVICE FOR A METHOD OF MODELLING A PHYSICAL STRUCTURE

(75) Inventor: Aravinda Thimmapuram, Bangalore (IN)

(73) Assignee: NXP B.V., Eindhoven (NL)

(21) Appl. No.: 12/672,021

(22) PCT Filed: Jul. 30, 2008
(86) PCT No.: PCT/IB2008/053064

§ 371 Date: Feb. 3, 2010

(30) Foreign Application Priority Data
Aug. 7, 2007 (EP) 07113933.1

(51) Int. Cl. G06F 17/50

(52) U.S. Cl. 703/15

(57) ABSTRACT

A device (100) for modelling a physical structure by a number of finite state machines comprising a simulation unit (114) adapted for simulating the physical structure by a number of finite state machines, a recording unit (104) adapted for recording state transitions for the number of finite state machines during simulating the physical structure on the basis of the number of finite state machines, and an analysis unit (106) adapted for analysing the recorded state transitions after simulating the physical structure on the basis of the number of finite state machines.

### FIELD OF THE INVENTION

The invention relates to a device for modelling a physical structure. Beyond this, the invention relates to a method of modelling a physical structure.

Moreover, the invention relates to a program element.

Furthermore, the invention relates to a computer-readable medium.

### BACKGROUND OF THE INVENTION

During the development of microprocessors, various designs are proposed and modified. Each design is tested for persistent errors (such as bugs) and for performance (such as speed), and modified accordingly to remove persistent errors and/or improve performance. Ultimately, a design is deemed sufficiently error-free and fast to be frozen and converted to hardware. Various software representations of the processor are employed during development. For example, a logical representation of the processor is provided in a hardware design language (“HDL”) such as Verilog. When the processor design is frozen, the HDL representation is converted to an arrangement of gates capable of implementing the processor logic on a semiconductor integrated circuit chip.

Also finite state machines (FSM) may be implemented for hardware modelling. A finite state machine (FSM) may be denoted as a model of behavior composed of a finite number of states, transitions between those states, and actions.

US 2005/0144585 discloses a system for synthesizing both a design under test (DUT) and its test environment (that is the testbench for the DUT) into an equivalent structural model suitable for execution on a reconfigurable hardware platform. This may be achieved without any change in the existing verification methodology. Behavioural HDL may be translated into a form that can be executed on a reconfigurable hardware platform. Sets of compilation transforms are provided, which convert behavioural constructs into RTL constructs that can be directly mapped onto an emulator. Such transforms are provided by introducing the concepts of a behavioural clock and a time advance finite state machine (FSM) that determines simulation time and sequences of concurrent computing blocks in the DUT and the testbench.

However, conventional finite state machine systems may suffer from inefficient processing characteristics.

### OBJECT AND SUMMARY OF THE INVENTION

It is an object of the invention to provide a finite state machine system having a proper performance.

In order to achieve the object defined above, a device for modelling a physical structure, a method of modelling a physical structure, a program element, and a computer-readable medium according to the independent claims are provided.

According to an exemplary embodiment of the invention, a (for instance computer-based) device for modelling a physical structure by a number of finite state machines is provided, the device comprising a simulation unit adapted for simulating the physical structure by a number of finite state machines, a recording unit adapted for recording state transitions for the number of finite state machines during simulating the physical structure on the basis of the number of finite state machines, and an analysis unit adapted for analysing the recorded state transitions after simulating the physical structure on the basis of the number of finite state machines.

According to another exemplary embodiment of the invention, a (for instance computer-based) method of modelling a physical structure by a number of finite state machines is provided, the method comprising simulating the physical structure by a number of finite state machines, recording state transitions for the number of finite state machines during simulating the physical structure on the basis of the number of finite state machines, and analysing the recorded state transitions after simulating the physical structure on the basis of the number of finite state machines.

According to still another exemplary embodiment of the invention, a program element (for instance a software routine, in source code or in executable code) is provided, which, when being executed by a processor (such as a microprocessor or a CPU), is adapted to control or carry out a modelling method having the above mentioned features.

According to yet another exemplary embodiment of the invention, a computer-readable medium (for instance a CD, a DVD, a USB stick, a floppy disk or a harddisk) is provided, in which a computer program is stored which, when being executed by a processor (such as a microprocessor or a CPU), is adapted to control or carry out a modelling method having the above mentioned features.

Data processing for hardware simulation purposes which may be performed according to embodiments of the invention can be realized by a computer program, that is by software, or by using one or more special electronic optimization circuits, that is in hardware, or in hybrid form, that is by means of software components and hardware components.

The term “physical structure” may particularly denote any object (particularly any technical apparatus, member, or a portion thereof) in the real world which may be under development or analysis and shall therefore be investigated by a specific finite state machine analysis. The physical structure may be a device under test (DUT). Thus, during the finite state machine analysis, a virtual pendent of the physical structure may be investigated. The physical structure may be a monolithically integrated circuit such as a memory device, for instance an SDRAM (“Synchronous Dynamic Random Access Memory”).

The term “finite state machine” may particularly denote a model of computation comprising a set of states, a start state, an input alphabet, and a transition function that maps input symbols and current states to a next state. Computation begins in the start state with an input string. It changes to new states depending on the transition function.

According to an exemplary embodiment of the invention, a system of modelling hardware functionality is provided. Such a system may comprise the implementation of the logic of a hardware function on the basis of a set of finite state machines (FSM). In a simulation step, a recording of transition states of the finite state machines may be performed. In an analyzing step, determining a number of cycles it takes to move from one state to another and the cycles consumed in each state may perform a determination of cycle behaviour of the modelled hardware functionality.

By taking this measure, it may be possible to achieve a complete separation of cycles from functional description for modelling control dominated IPs such as an SDRAM memory. This may be achieved by using state transition information. Thus, the simulation speed may not suffer any longer with additional cycle information. Also, it may be possible that an addition of cycles will not affect the simulation speed. This may also contribute to improve hardware modelling, which can then be carried out with high precision and low computational burden. Therefore, exemplary embodiments of the invention utilise the state transition information to achieve the separation of functionality and timing and thus significantly reduce the effort needed to develop and tune simulation models.

Higher-level languages such as C++/SystemC may be used for modelling hardware IPs. SystemC may be considered as a hardware description language like VHDL and Verilog. It may be denoted precisely as a system description language, since it exhibits its real power at the behaviour level of modelling. SystemC may include a set of library routines and macros implemented in C++, which makes it possible to simulate concurrent processes, each described by ordinary C++ syntax.

Modelling can be done in various abstraction levels like functional (programmer's view), cycle accurate level. Cycle accurate abstraction level may be useful for making architecture choices early in a design cycle. On the other hand, modelling at cycle accurate level may be a high effort consuming activity because of the huge amount of details to be modelled. According to an exemplary embodiment of the invention, a specific modelling mechanism for implementing cycle accurate abstraction level may be provided which may significantly reduce the effort to develop and tune the cycle accurate simulation models particularly for control dominated IPs. Thus, a method for modelling cycle accurate simulation models particularly using C++ may be provided.

According to an exemplary embodiment, the state transitions may be collected and may be dumped to a file. These transitions may be later (as part of a post-processing) combined with a prior database to calculate cycles consumed for the simulation.

Next, further exemplary embodiments of the device will be explained. However, these embodiments also apply to the method, to the program element, and to the computer-readable medium.

The simulation unit may be adapted for simulating the physical structure by a plurality of interconnected finite state machines. Therefore, not only a single finite state machine (FSM) may be used, but a complex system may be modelled in a realistic manner by a larger number of finite state machines. This may allow to accurately map the functional behaviour of the physical structure to a virtual, theoretical model.

The simulation unit may be adapted for simulating, by the number of finite state machines, a logic in accordance with a function provided by the physical structure. For instance, a programming, reading and/or erase procedure of a memory product such as an SDRAM may be simulated with the modelling unit in a meaningful manner. This may involve a sequence of controlling individual memory cells, rows of memory cells, or columns of memory cells by applying specific electric potentials to terminals of a memory device. This may further involve a sequence of sampling individual memory cells, rows of memory cells, or columns of memory cells by detecting specific electric potentials at terminals of the memory device.

The analysis unit may be adapted for determining cycle behaviour by analysing the recorded state transitions post simulation. Thus, after a simulation procedure, the completely separated cycle properties or dynamical properties of the physical structure during operation may be analyzed. The separation of different calculation procedures may keep the computational burden small and the results reliable. Particularly, cycle behaviour may be determined quantitatively so that a quantitative result regarding the simulated timing behaviour/time consumption may be obtained.

The recording unit may be adapted for recording the state transitions in a data file or in a database. For instance, the state transitions may be stored in a computer file or may be stored in a storage unit such as a harddisk.

The recording unit may further be adapted for recording the state transitions in a format in which at least a part of the state transitions, particularly each state transition, in at least a part of the number of finite state machines, particularly in each of the number of finite state machines, is characterized by a set or tuple of linked data items comprising a simulation time (for instance in seconds or in arbitrary units), an index indicative of a corresponding one of the number of finite state machines (for instance an identifier characterizing a specific one of the finite state machines under consideration, for example by a number), and an indication of a transition from a start state to an end state (that is to say an indication at which initial configuration the system starts, and at which final position the system ends). Such a set of data includes meaningful information characterizing a state transition and allows for a straightforward computation.

The recording unit may be adapted for chronologically arranging the sets of data items. In other words, the sets of data may be stored in an order in which the time is the sorting criteria.

The recording unit may further be adapted for rearranging/reordering the (for instance chronologically ordered) set of data items so that, for each of the number of finite state machines, state transitions of the corresponding finite state machine are grouped. By such a grouping, the amount of data may be restructured, thereby allowing for an efficient computational simulation of the system for each of the finite state machines.

According to an embodiment of the invention, the analysis unit may be adapted for analysing the recorded state transitions using the following sequence:
sorting the sets using the simulation time as sorting criteria (for instance sorting the state transition information from the simulation based on the simulation time);
grouping all sets having the same simulation time to form groups (particularly the transitions occurring at the same simulation time may be grouped);
extracting, from each group, the set having a highest delay (for example pick the state transition with highest delay for the given simulation time);
adding the highest delays for determining a number of consumed cycles (in other words, the individual cycles may be added for each simulation time to arrive at the total number of consumed cycles).

This may allow to quantitatively determine the cycle consumption, and may allow to derive meaningful information regarding a physical structure being a product under development.

The device may be adapted for modelling a functionality of the physical structure, particularly for modelling functionality of an electronic circuit, more particularly for modelling functionality of an SDRAM memory. However, using such a system, other physical structures such as other electronic circuits, logic circuits, or complex machines such as industrial facilities, etc. may be simulated in a short time and in a reliable manner.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a system for modelling a physical structure according to an exemplary embodiment of the invention.

FIG. 2 illustrates a SystemC IP as a set of finite state machines according to an exemplary embodiment of the invention.

FIG. 3 illustrates a format according to which state transitions are recorded in a file according to an exemplary embodiment of the invention.

FIG. 4 illustrates a file containing the state transition information of FIG. 3 at the end of a simulation run according to an exemplary embodiment of the invention.

FIG. 5 and FIG. 6 illustrate a database of cycles needed for state transitions for two different finite state machines according to an exemplary embodiment of the invention.

FIG. 7 illustrates a table obtained during a first step of a transition-information evaluating algorithm according to an exemplary embodiment of the invention.

FIG. 8 illustrates a table obtained during a second step of a transition-information evaluating algorithm according to the exemplary embodiment of the invention.

FIG. 9 and FIG. 10 illustrate a table obtained during a third step of a transition-information evaluating algorithm according to the exemplary embodiment of the invention.

FIG. 11 illustrates state transitions for a read operation of a simulated SDRAM memory according to an exemplary embodiment of the invention.

FIG. 12 illustrates information regarding state transitions to be recorded in a trace file during the coarse of simulation according to an exemplary embodiment of the invention.

FIG. 13 illustrates a format according to which the information of FIG. 12 is stored according to an exemplary embodiment of the invention.

FIG. 14 illustrates a state transitions table according to an exemplary embodiment of the invention.

FIG. 15 illustrates a database of cycles for state transitions according to an exemplary embodiment of the invention.

FIG. 16 illustrates a sorting of the state transition information from the simulation on simulation time according to an exemplary embodiment of the invention.

FIG. 17 illustrates a grouping of all the transitions of the same simulation time according to an exemplary embodiment of the invention.

FIG. 18 illustrates picking the state transition with highest delay for the given simulation time according to an exemplary embodiment of the invention.

### DESCRIPTION OF EMBODIMENTS

The illustration in the drawing is schematically. In different drawings, similar or identical elements are provided with the same reference signs.

Conventionally, developing a cycle accurate simulation model is an intensive activity involving high effort because of the huge amount of cycle details to be modelled. Embodiments of the invention are based on the insight that this task can be simplified if functionality can be cleanly separated from cycle information. This enables tuning cycles without changing the functionality. Embodiments of the invention may allow performing such a separation, wherein functionality and cycle behaviour are completely separated, and the simulation speed does not suffer from an addition of cycle information.

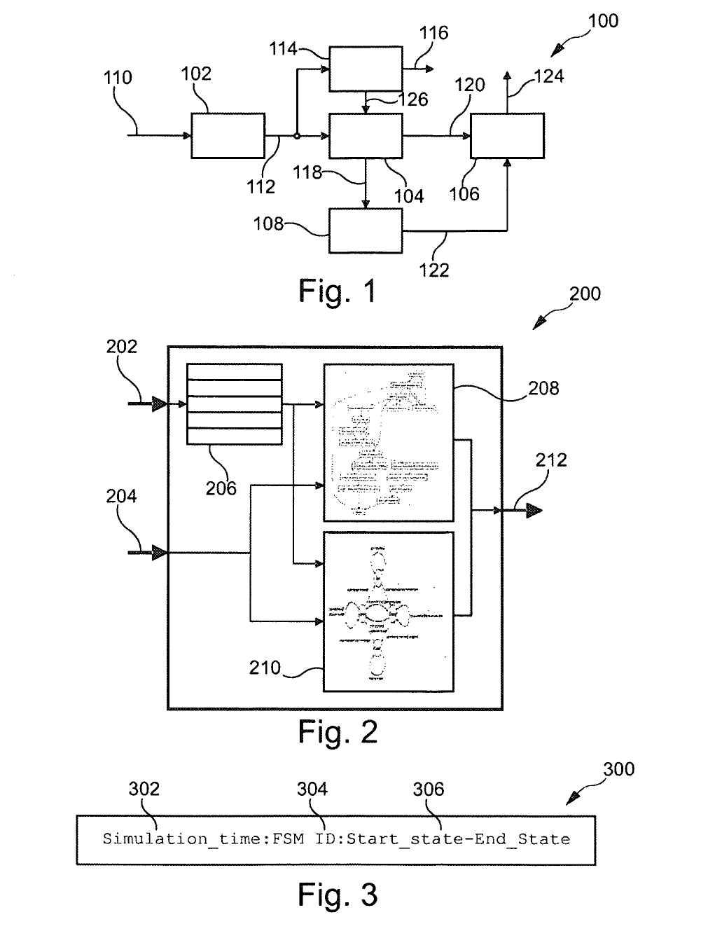

In the following, referring to FIG. 1, a device 100 for modelling a physical structure according to an exemplary embodiment of the invention will be explained.

The device 100 may be a computer-based system, which may comprise processing resources provided by a processor such as a central processing unit (CPU) or a microprocessor. Beyond this, data storage capability may be provided, for instance by a memory unit such as an EEPROM.

Input information 110 indicative of the physical structure such as an SDRAM memory under development, is supplied to an optional modelling unit 102 which is adapted for modelling the physical structure by a number of finite state machines, for instance by two or more finite state machines (FSM). Alternatively, a user may directly input a model to the system 100.

Data 112 indicative of the model may be supplied in parallel to a simulation unit 114 and to a recording unit 104. The simulation unit 114 is adapted for simulating the physical structure on the basis of the number of finite state machines involved in the model configured by the modelling unit 102 or input directly. An output of such a simulation is supplied as first output data 116 at an output of the simulation unit 114.

Moreover, the model data 112 provided by the modelling unit 102 is supplied to an input of the recording unit 104 which is adapted for recording state transitions for the number of finite state machines during simulating the physical structure on the basis of the number of finite state machines. The recording unit 104 may also be supplied with simulation data 126 provided by the simulation unit 114. A result of the recording procedure may be stored as recording data 118 in a database unit 108.

Furthermore, the recorded state transition information may be supplied as data 120 directly from the recording unit 104 to an analysis unit 106, or via an access to the database unit 108, which may also supply data 122 to the analysis unit 106. The analysis unit 106 is then adapted for analyzing the recorded state transitions after (or at least independently from) simulating the physical structure on the basis of the number of finite state machines. At a second output 124 of the analysis unit 106, a result of the evaluation of the transition characteristic may be provided. The outputs 116, 124 in combination may provide a meaningful set of parameters, which is indicative of the performance of the simulated physical structure.

Further details of such a procedure will be explained below referring to FIG. 2 to FIG. 18.

FIG. 2 shows a scheme 200 that characterizes SystemC IP as a set of finite state machines (FSM).

An input 202 may be supplied to a register bank unit 206, and an input 204 may be supplied to a first finite state machine (FSM) 208 and a second finite state machine (FSM) 210, respectively. After corresponding processing, data are provided at an output 212.

The SystemC IP 200 can be generalized as a set of finite state machines 208, 210 implementing the logic of the IP and taking input from IP registers 206 and IP input 202, 204 and contributing to IP output 212.

Functionality of the IP is governed by the functionality of the FSMs 208, 210 and its cycle behaviour is determined by the cycles it takes to move from one state to another and the cycles consumed in each state. To model functionality, it is possible to model all states of the FSM 208, 210 accurately and their transitions. To model the cycles, it is possible to record all the state transitions. Post-simulation, the states transitions can be composed with a database of cycle information to arrive at the cycle consumed for the complete simulation.

FIG. 3 shows a scheme 300 illustrating a format in which the state transitions are recorded.

The format 300 may include a first data item 302 indicative of the simulation time. A second data item 304 may be indicative of a number characterizing a corresponding FSM. A third data item 306 may be indicative of a start state and an end state, that is a state before and a state after a transition.

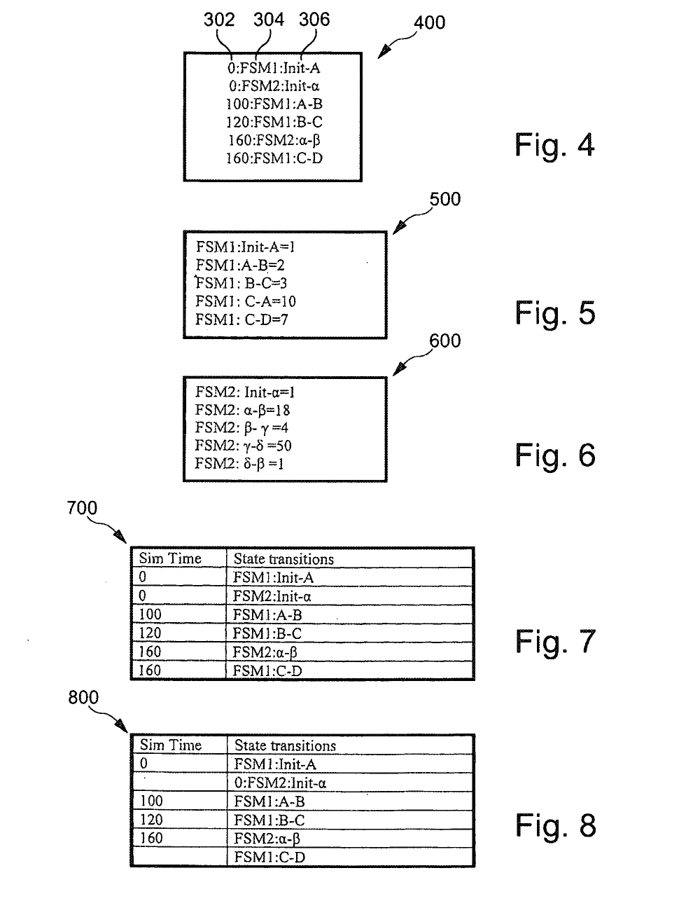

FIG. 4 shows a scheme 400 illustrating how a file may look like at the end of the simulation. Each row of the scheme 400 in FIG. 4 corresponds to a specific state transition.

For each of the FSMs 208, 210, a corresponding database 500, 600 of cycles needed for a state transition may be prepared. For the given example, the databases 500, 600 have the appearance as shown in FIG. 5 and FIG. 6. The scheme 500 corresponds to the first FSM 208, whereas the scheme 600 corresponds to the second FSM 210.

As will be described in the following referring to FIG. 7 to FIG. 10, state transition information from the simulation run is composed with the database to produce the cycles consumed. This may be performed in accordance with the following procedure for the composition:

FIG. 7 shows a scheme 700, which is obtained after sorting the state transition information from the simulation using the simulation time as sorting criteria.

FIG. 8 shows a scheme 800, which is obtained after grouping all the state transitions having the same simulation time.

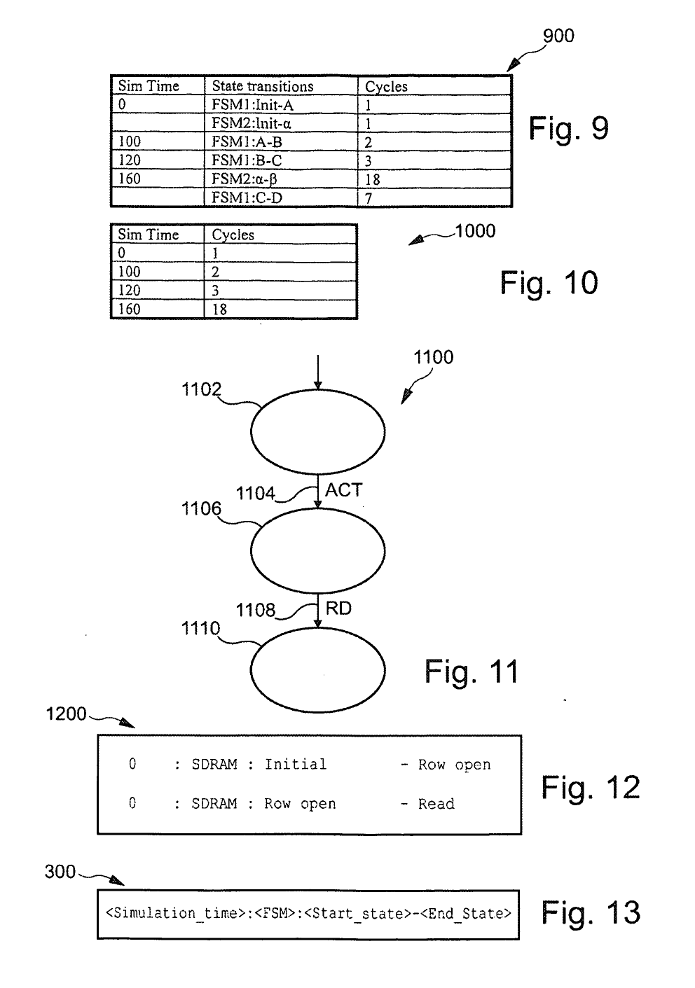

A scheme 900 shown in FIG. 9 and a scheme 1000 shown in FIG. 10 are obtained after picking the state transition with a highest delay for the given simulation times.

At the end of the procedure, the cycles for each simulation time may be added to derive at the total number of consumed cycles, which in the present example is 1+2+3+18=24 cycles.

However, alternatively, other scenarios are possible where FSMs being dependent on each other can also be accommodated. This involves an appropriate database that contains these inter-FSM transitions.

In the following, referring to FIG. 11 to FIG. 18, a further specific example of a method according to an exemplary embodiment of the invention will be explained which is specifically related to SDRAM memory simulation.

FIG. 11 shows a diagram 1100 illustrating state transitions for a “read” operation.

At the beginning, a memory is in an “initial” state 1102. In the activation procedure 1104 indicated by the transition “ACT”, the memory is activated. Consequently, the memory is brought into a “row open” state 1106. By performing a state transition 1108 indicated by the transition “RD”, the system is brought into a “read” state 1110.

Thus, FIG. 11 shows the example of the implementation of an SDRAM memory. FIG. 11 shows the state transitions of SDRAM for servicing a read command starting from the clean state 1102 (where no row is open, yet). The state transitions 1104, 1108 are recorded during the coarse of simulation into a trace file, which is shown in FIG. 12 as a scheme 1200. The format of such a file is shown in FIG. 13, which corresponds to the scheme 300 shown in FIG. 3.

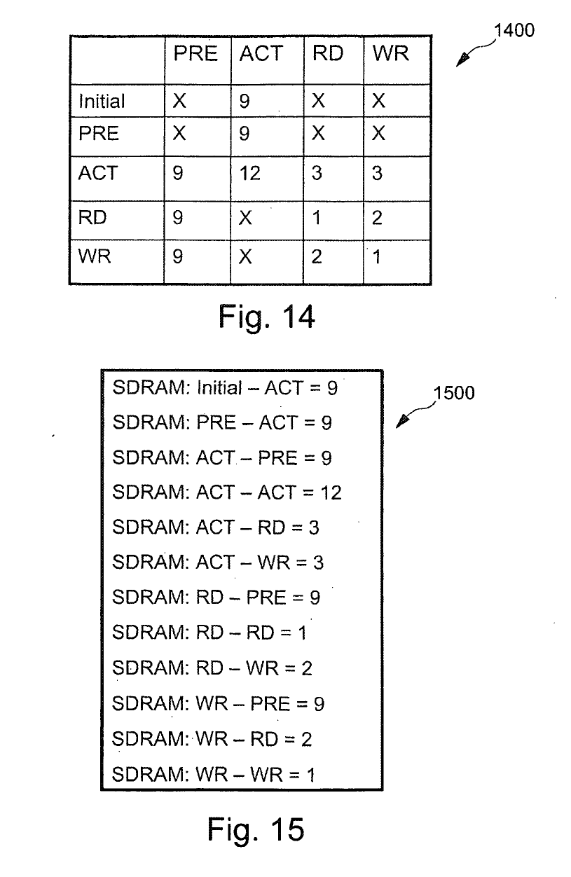

FIG. 14 shows a state transitions table 1400 and FIG. 15 shows a database 1500 of cycles for state transitions, which can be obtained by making a database of cycles needed for each state transition.

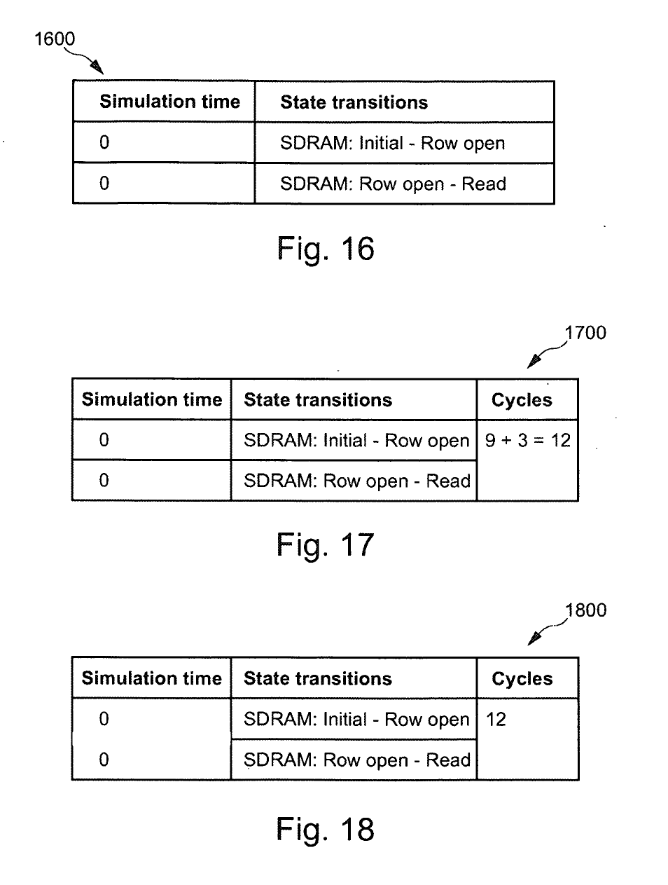

In order to obtain the scheme 1600 shown in FIG. 16, the system sorts the state transition information dump from the simulation on simulation time.

As can be taken from a scheme 1700 shown in FIG. 17, all the transitions may be grouped in the same simulation time, and the delays for all the transitions for each FSM may be added up.

To obtain a scheme 1800 shown in FIG. 18, the state transition with the highest delay for the given simulation time will be picked. As a result in the present example, a total number 12 of cycles consumed is obtained. This number may be obtained by adding the cycles of each simulation time to arrive at the total cycles consumed.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A device for modelling a physical structure by a number of finite state machines, the device comprising
a simulation unit adapted for simulating the physical structure by the number of finite state machines;
a recording unit adapted for recording state transitions for the number of finite state machines during simulating the physical structure on the basis of the number of finite state machines;
an analysis unit adapted for analysing the recorded state transitions after simulating the physical structure on the basis of the number of finite state machines.

2. The device according to claim 1,
wherein the simulation unit is adapted for simulating the physical structure by a plurality of interconnected finite state machines.

3. The device according to claim 1,
wherein the simulation unit is adapted for simulating, by the number of finite state machines, a logic in accordance with a function provided by the physical structure.

4. The device according to claim 1,
wherein the analysis unit is adapted for determining cycle behaviour, particularly for quantitatively determining cycle behaviour, by analysing the recorded state transitions.

5. The device according to claim 1,
wherein the recording unit is adapted for recording the state transitions in a data file or in a database.

6. The device according to claim 1,
wherein the recording unit is adapted for recording the state transitions in a format in which at least a part of the state transitions in at least a part of the number of finite state machines is characterized by a set of data items comprising a simulation time, an index indicative of a corresponding one of the number of finite state machines, and an indication characterizing a transition from a start state to an end state.

7. The device according to claim 6,
wherein the recording unit is adapted for chronologically arranging the sets of data items.

8. The device according to claim 7,
wherein the recording unit is adapted for rearranging the sets of data items so that, for at least a part of the number of finite state machines, state transitions for a corresponding one of the number of finite state machines are grouped.

9. The device according to claim 6,
wherein the analysis unit is adapted for analysing the recorded state transitions by the following sequence:
sorting the sets using the simulation time as sorting criteria;
grouping all sets at the same simulation time to form groups;
extracting, from each group, the set having a highest delay;
adding the highest delays for determining a total number of consumed cycles.

10. The device according to claim 1,
adapted for modelling a functionality of the physical structure, particularly for modelling a functionality of an electronic circuit, more particularly for modelling a functionality of an SDRAM memory.

11. A method of modelling a physical structure by a number of finite state machines, the method comprising
simulating the physical structure by a number of finite state machines;
recording state transitions for the number of finite state machines during simulating the physical structure on the basis of the number of finite state machines;
analysing the recorded state transitions after simulating the physical structure on the basis of the number of finite state machines.

12. A computer-readable medium, in which a computer program of modelling a physical structure is stored, which computer program, when being executed by a processor, is adapted to carry out or control a method according to claim 11.

13. A program element of modelling a physical structure, which program element, when being executed by a processor, is adapted to carry out or control a method according to claim 11.
